(19) United States
(12) Patent Application Publication
(10) Pub. No.: US 2015/0143289 A1
(43) Pub. Date: May 21, 2015

(54) AUTOMATIC CHECK BOX INTERACTION

(71) Applicant: International Business Machines Corporation, Armonk, NY (US)

(72) Inventor: Siddharth K. Saraya, West Bengal (IN)

(73) Assignee: International Business Machines Corporation, Armonk, NY (US)

(21) Appl. No.: 14/085,901

(22) Filed: Nov. 21, 2013

(51) Int. Cl. G06F 3/0482

(52) U.S. Cl. CPC G06F 3/0482
USPC 715/808

(57) ABSTRACT

In a method for automatically interacting with one or more check boxes in relation to another check box of a plurality of displayed check boxes, one or more processors receive an indication of an interaction with a check box of a plurality of displayed check boxes in a user interface. The one or more processors cause instructions for interacting with one or more check boxes of the plurality of check boxes in relation to the interacted with check box to be displayed in the user interface. The one or more processors receive an indication that a instruction is selected. The one or more processors cause an interaction with the one or more check boxes of the plurality of check boxes, wherein the interaction is specified by the selected instruction.

### FIELD OF THE INVENTION

The present invention relates generally to graphical user interfaces, and more particularly to automatic selection and/or deselection of check boxes.

### BACKGROUND OF THE INVENTION

In computing, a check box is a graphical user interface element that represents one choice of at least two options. A caption that describes the meaning of the check box is normally displayed adjacent to the check box. Unselected check boxes are often displayed as a square box that contains a white space. The user may use a mouse, keyboard, or other human interface device to manually select a check box. After the user selects an unselected check box, the selected check box usually includes a tick mark. A tick mark may be the letter “x” or a check mark. A tick mark may also be a color change. The user can deselect a selected box by selecting a selected check box. The deselected check box no longer includes the tick mark. Some applications use check boxes that allow an indeterminate state. This third state is usually indicated by a square or dash in the check box which indicates that the check box is neither selected nor unselected. For most applications, a check box is either selected and includes a tick mark or the check box is unselected and does not include a tick mark.

The user, using a user interface of a computing device, may select one check box that represents one choice of at least two options. For example, the user may select “yes” (selected check box) or the user may select “no” (unselected check box) for a simple yes/no question. The user may select more than one check box of the at least two options. Some applications include a check box with the caption “select all.” When a user selects a check box with the caption “select all,” all unselected check boxes are selected. Some applications also include a check box with the caption “deselect all.” When a user selects a check box with the caption “deselect all,” all selected check boxes are deselected.

### SUMMARY

Aspects of embodiments of the present invention disclose a method, computer program product, and computer system for automatically interacting with one or more check boxes in relation to another check box of a plurality of displayed check boxes. One or more processors receive an indication of an interaction with a check box of a plurality of displayed check boxes in a user interface. The one or more processors cause instructions for interacting with one or more check boxes of the plurality of check boxes in relation to the interacted with check box to be displayed in the user interface. The one or more processors receive an indication that an instruction is selected. The one or more processors cause an interaction with the one or more check boxes of the plurality of check boxes, wherein the interaction is specified by the selected instruction.

### BRIEF DESCRIPTION OF THE SEVERAL VIEWS OF THE DRAWINGS

FIG. 1 is a functional block diagram illustrating a computing device, in accordance with one embodiment of the present invention.

FIGS. 2A-D depict exemplary views of a user interface throughout the operation of a check box interaction program of the computing device of FIG. 1, in accordance with one embodiment of the present invention.

FIG. 3 is a flowchart depicting operational steps of a check box interaction program, executing within the environment of FIG. 1, for automatically interacting with one or more check boxes in relation to another check box of a plurality of displayed check boxes, in accordance with one embodiment of the present invention.

FIG. 4 depicts a block diagram of components of the server computers and the client computer of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

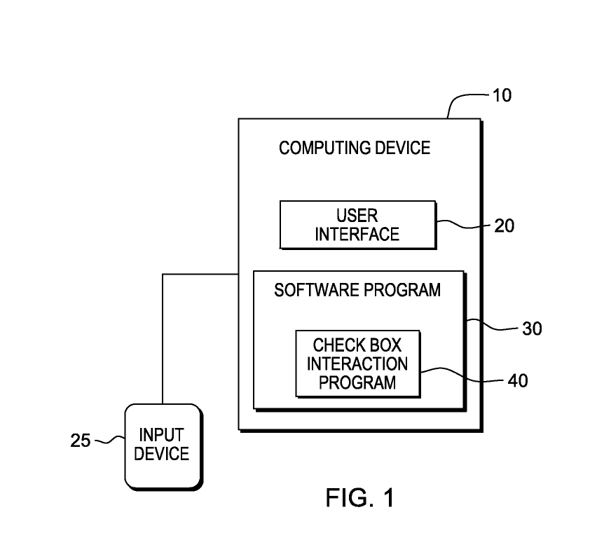

The present invention will now be described in detail with reference to the Figures. FIG. 1 depicts a diagram of computing device 10 in accordance with one embodiment of the present invention. FIG. 1 provides only an illustration of one embodiment and does not imply any limitations with regard to the environments in which different embodiments may be implemented.

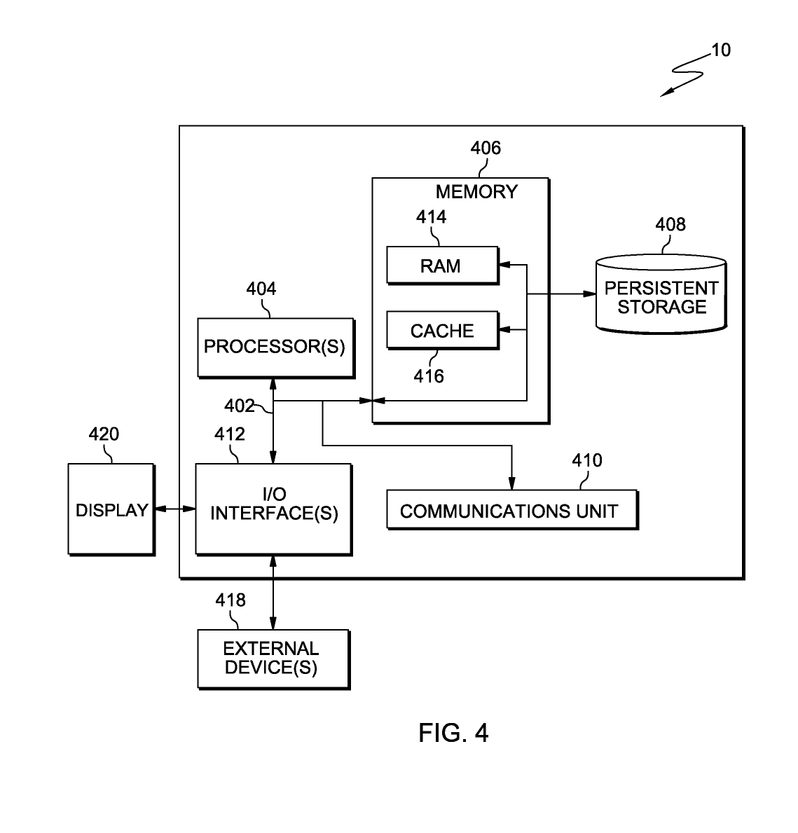

Computing device 10 may be a desktop computer, laptop computer, tablet computer, personal digital assistant (PDA), smart phone, or any other device capable of executing program instructions. In the depicted embodiment, computing device 10 includes user interface 20, software program 30, and check box interaction program 40. In the depicted embodiment, computing device 10 is connected to input device 25. In one embodiment, computing device 10 includes components described in reference to FIG. 4.

User Interface (UI) 20 operates on computing device 10 to visualize content, such as menus and icons, and to allow a user to interact with an application accessible to computing device 10. For example, UI 20 can allow a user operating computing device 10 to interact with software program 30 and check box interaction program 40. In another embodiment, UI 20 may comprise one or more interfaces such as an operating system interface and/or application interfaces. In the depicted embodiment, UI 20 determines the position within an interface of a cursor associated with input device 25 and presents information organized in windows and represented with icons. Available commands are compiled together in menus, and actions are performed making gestures with the cursor.

Input device 25 is a pointing device that operates to control motion of a cursor displayed on computing device 10. The cursor is an indictor that shows a position on UI 20. UI 20 responds to input from input device 25. In one embodiment, input device 25 controls the motion of the cursor in two dimensions in UI 20.

In one embodiment, input device 25 is a distinct piece of hardware that is connected to computing device 10. For example, input device 25 is a mouse connected to computing device 10 by a wire that is plugged into a USB port of computing device 10. In another example, input device 25 is a wireless mouse that transmits data via infrared radiation or radio to computing device 10 through a receiver. The receiver of input device 25 may be connected to computing device 10 through as USB port or the receiver may be part of the hardware included in computing device 10. In another embodiment, input device 25 is part of the hardware included in computing device 10. For example, computing device 10 includes an electronic visual display that can be controlled through single or multi-touch gestures by touching the screen with one or more fingers (e.g., a touch screen). Input device 25 may be a ball mouse, optical mouse, laser mouse, three dimensional mouse, pointing stick, finger, touch pad, keyboard, or any other type of pointing device connected to computing device 10 that allows the user to interact with content in UI 20.

In the depicted embodiment, a user operating computing device 10 may use input device 25 to click and select content displayed in UI 20. For example, input device 25 can be used to interact with files, programs, or check boxes displayed by a user interface of a program. Input device 25 can also be used to hover over content displayed in UI 20. Hovering is a state in which the cursor is positioned within the bounds of a specific area for a predetermined amount of time. For example, input device 25 can hover the cursor over a check box. In one embodiment, hovering does not cause the check box to be selected or deselected. Input device 25 is not clicked when hovering over an object.

Software program 30 resides on computing device 10. A user at computing device 10, using UI 20, can interact with software program 30. In the depicted embodiment, software program 30 is a generic software program that includes sequences of instructions written to perform a specified task with computing device 10. For example, software program 30 is a web browser. In another example, software program 30 is a graphing program. In the depicted embodiment, software program 30 accesses check box interaction program 40 whenever software program 30 displays content that includes check boxes. For example, software program 30 sends an indication to check box interaction program 40 that software program 30 is displaying content that includes check boxes. In another embodiment, check box interaction program 40 periodically accesses software program 30 to determine if software program 30 is displaying content that includes check boxes. In the depicted embodiment, software program 30 includes check box interaction program 40.

Check box interaction program 40 operates to automatically interact with one or more check boxes in relation to another check box of a plurality of displayed check boxes. In the depicted embodiment, check box interaction program 40 resides on computing device 10 and is included as a function of software program 30. In another embodiment, check box interaction program 40 is a stand-alone program accessible to software program 30 and UI 20. In yet another embodiment, check box interaction program 40 is included as a function of UI 20. In another embodiment, check box interaction program 40 is included as a function of another program, provided that check box interaction program 40 is accessible to software program 30. In yet another embodiment, check box interaction program 40 resides on another computing device, or a server computer, provided that check box interaction program 40 is accessible to software program 30 and UI 20.

In one example, software program 30 displays a list of ten options with corresponding check boxes (not shown). Each option is associated with one check box. In the depicted embodiment, the cursor associated with input device 25 hovers over the third check box that is associated with the third option. In one embodiment, UI 20 sends an indication to check box interaction program 40 that the cursor is hovering over one unselected check box. In another embodiment, software program 30 sends an indication to check box interaction program 40 that the cursor is hovering over one unselected check box. In another embodiment, if input device 25 is a touch screen, a user may touch input device 25 once over the third check box that is associated with the third option. Touching once may act as an indication to check box interaction program 40 that the cursor is hovering over one unselected check box even though if there is no cursor because input device 25 is a touch screen.

In one embodiment, check box interaction program 40 causes UI 20 to display special interaction instructions with corresponding check boxes. In another embodiment, check box interaction program 40 sends an instruction to software program 30 to display check boxes, and software program 30 causes UI 20 to display a context menu that includes a list of special interaction instructions. Special interaction instructions may include instructions such as “select all above,” “select, and select all above,” “select all below,” and “select, and select all below.” In another embodiment, special interaction instructions include instructions that describe other orientations, such as “select all to the left,” “select all to the right,” “deselect all to the left,” and “deselect all to the right.” In yet another embodiment, special interaction instructions include other instructions.

In one embodiment, check box interaction program 40 causes the special interaction instructions to be displayed in a hoverbox. A hoverbox is a popup window that appears when a cursor associated with a mouse is placed over an icon for a short period of time without clicking on the icon. The hoverbox is displayed in response to the cursor associated with input device 25 hovering over a check box corresponding to one of the options in the list of options. The hoverbox remains displayed even after the cursor associated with input device 25 is moved from the check box to the special selection instructions. In another embodiment, check box interaction program 40 causes the special selection instructions to be displayed in a modeless window. A modeless window is a window that does not require a user to interact with it before the user can return to operating a parent application (e.g. software program 30). The user can, for example, continue to interact with software program 30, check box interaction program 40, or any other program on computing device 30 while the modeless window is open. In yet another embodiment, check box interaction program 40 causes special selection instructions to be displayed in another location accessible to the user. For example, check box interaction program 40 causes the special selection instructions to be displayed in a margin next to the check boxes associated with the list of options.

In one example, UI 20 receives a special selection instruction in response to the cursor hovering over a third check box of a plurality of check boxes, wherein the special selection instruction is associated with the third check box and comprises the special selection instruction “select all above.” Check box interaction program 40 causes all of the unselected check boxes above the third check box to be selected. Check box interaction program 40 causes the first two unselected check boxes to be selected and the third check box remains unselected. In another example, UI 20 receives a special selection instruction in response to the cursor hovering over a third check box of a plurality of check boxes, wherein the special selection instruction is associated with the third check box and comprises the special selection instruction “select, and select all above.” Check box interaction program 40 causes the third box to be selected and all of the unselected check boxes above the third check box to be selected, i.e., check box interaction program 40 causes the first three unselected check boxes to be selected.

In another example, UI 20 receives a special selection instruction in response to the cursor hovering over a third check box of a plurality of check boxes, wherein the special selection instruction is associated with the third check box and comprises the special selection instruction “select all below.” Check box interaction program 40 causes all of the unselected check boxes below the third check box to be selected. Check box interaction program 40 causes the last seven check boxes to be selected and the third check box remains unselected. In another example, UI 20 receives a special selection instruction in response to the cursor hovering over a third check box of a plurality of check boxes, wherein the special selection instruction is associated with the third check box and comprises the special selection instruction “select, and select all below.” Check box interaction program 40 causes the third box to be selected and all of the unselected check boxes listed below the third check box to be selected, i.e., check box interaction program 40 causes the last eight unselected check boxes to be selected.

In another embodiment, the first check box of the list of ten options is selected. The cursor associated with input device 25 hovers over the third check box of the list of ten options, which is unselected. In another embodiment, if input device 25 is a touch screen, a user may touch input device 25 once over the third check box. Touching once may act as an indication to check box interaction program 40 that the cursor is hovering over one unselected check box even though if there is no cursor because input device 25 is a touch screen. Check box interaction program 40 displays the special selection instructions. The special selection instruction “select all above” is selected. In one embodiment, check box interaction program 40 causes the second check box to be selected because the first check box is already selected. In another embodiment, check box interaction program 40 causes the second check box to be selected and the first check box to be deselected. In yet another embodiment, check box interaction program 40 prompts the user to indicate if the first selected check box should remain selected or if the first selected check box should be deselected. For example, check box interaction program 40 displays a modeless window that the user uses to indicate if the first selected check box should remain selected or if the first selected check box should be deselected.

In another embodiment, all ten of the check boxes associated with list of options for software program 30 are selected. The cursor associated with input device 25 hovers the cursor associated with input device 25 over the third selected check box that is associated with the third option. In another embodiment, if input device 25 is a touch screen, a user may touch input device 25 once over the third check box. Touching once may act as an indication to check box interaction program 40 that the cursor is hovering over one selected check box even though if there is no cursor because input device 25 is a touch screen. Check box interaction program 40 causes special selection instructions to be displayed. In one embodiment, special selection instructions include instructions such as “deselect all above,” “deselect, and deselect all above,” “deselect all below,” and “deselect, and deselect all below.”

For example, UI 20 receives a special selection instruction in response to the cursor hovering over a third check box of a plurality of check boxes, wherein the special selection instruction is associated with the third check box and comprises the special selection instruction “deselect all above.” Check box interaction program 40 causes all of the selected check boxes above the third check box to be deselected. Check box interaction program 40 causes the first two check boxes to be deselected and the third check box remains selected. In another example, UI 20 receives a special selection instruction in response to the cursor hovering over a third check box of a plurality of check boxes, wherein the special selection instruction is associated with the third check box and comprises the special selection instruction “deselect, and deselect all above.” Check box interaction program 40 causes the third box to be deselected and all of the check boxes above the third check box to be deselected. Check box interaction program 40 causes the first three check boxes to be deselected.

In another example, UI 20 receives a special selection instruction in response to the cursor hovering over a third check box of a plurality of check boxes, wherein the special selection instruction is associated with the third check box and comprises the special selection instruction “deselect all below.” Check box interaction program 40 causes all of the check boxes below the third check box to be deselected. Check box interaction program 40 causes the last seven check boxes to be deselected and the third check box remains deselected. In another example, UI 20 receives a special selection instruction in response to the cursor hovering over a third check box of a plurality of check boxes, wherein the special selection instruction is associated with the third check box and comprises the special selection instruction “deselect, and deselect all below.” Check box interaction program 40 causes the third box to be deselected and all of the check boxes below the third check box to be deselected. Check box interaction program 40 causes the last eight check boxes to be deselected.

In another embodiment, the first check box of the list of ten operational commands is unselected. The cursor associated with input device 25 hovers the cursor associated with input device 25 over the third check box of the list of ten options, which is selected. In another embodiment, if input device 25 is a touch screen, a user may touch input device 25 once over the third check box. Touching once may act as an indication to check box interaction program 40 that the cursor is hovering over one selected check box even though if there is no cursor because input device 25 is a touch screen. UI 20 receives a special selection instruction in response to the cursor hovering over a third check box of a plurality of check boxes, wherein the special selection instruction is associated with the third check box and comprises the special selection instruction “deselect all above.” In one embodiment, check box interaction program 40 causes the second check box to be deselected because the first check box is already unselected. In another embodiment, check box interaction program 40 causes the second check box to be deselected and the first check box to be selected. In yet another embodiment, check box interaction program 40 prompts the user to indicate if the first unselected check box should remain unselected or if the first selected check box should be selected. For example, check box interaction program 40 displays a modeless window that the user uses to indicate if the first unselected check box should remain unselected or if the first selected check box should be selected.

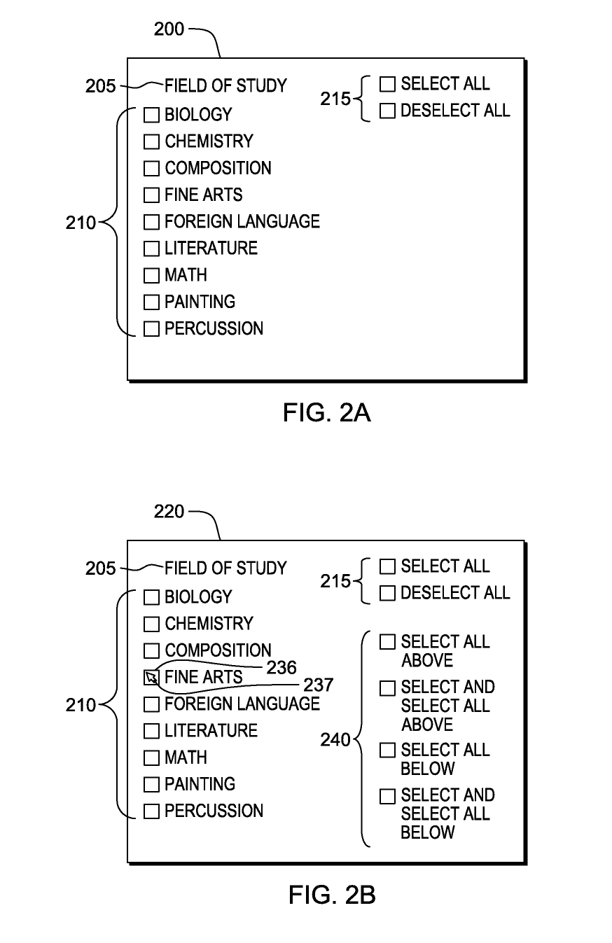

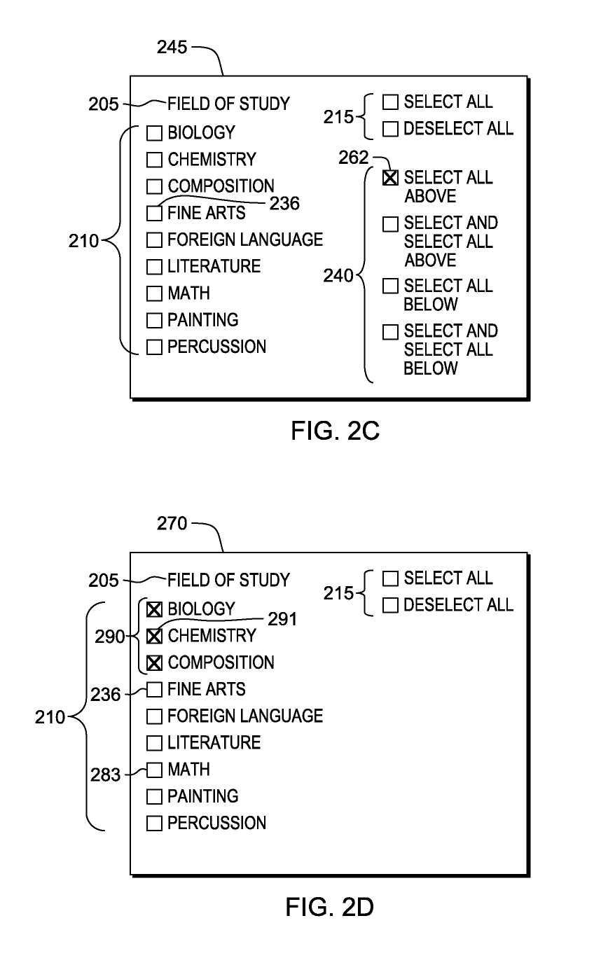

FIGS. 2A-D depict exemplary views of a user interface throughout the operation of a check box interaction program of the computing device of FIG. 1, in accordance with one embodiment of the present invention. A UI 200 of FIG. 2A, a UI 220 of FIG. 2B, a UI 245 of FIG. 2C, and a UI 270 of FIG. 2D are each an example of UI 20 of FIG. 1 in various states of operation and, in the depicted embodiment, allow content from software program 30 and check box interaction program 40 to be displayed.

FIG. 2A depicts a display of UI 200 when software program 30 is operating on computing device 10. In the depicted embodiment, UI 200 displays a list of fields of study. List title 205 is a title of the list of fields of study displayed by software program 30. Check boxes 210 are each associated with a field of study of the list of fields of study. Each check box of check boxes 210 is unselected. Selection check boxes 215 are check boxes that operating software program 30 can select to either automatically select or automatically deselect all of check boxes 210. For example, if the “select all” selection check box is selected, all of check boxes 210 are automatically selected. In another example, if all of check boxes 210 are already selected, selection of the “deselect all” selection check box causes all of check boxes 210 to be automatically deselected.

FIG. 2B depicts a display of UI 220 when check box interaction program 40 is operating on computing device 10. List title 205, check boxes 210, and selection check boxes 215 are the same as FIG. 2A. Cursor 237 indicates the position of input device 25 in UI 220. In the depicted embodiment, cursor 237 hovers above check box 236. Check box 236 is associated with the field of study “fine arts.” In the depicted embodiment, hovers cursor 237 hovers over check box 236. Check box interaction program 40 causes special selection instructions 240 to be displayed. In the depicted embodiment, special interaction instructions 240 are each associated with a check box is not selected. In the depicted embodiment, each instruction associated with a special interaction instruction in reference to check box 236.

The first special interaction instruction, “select all above,” refers to all check boxes in the field of study list that are listed above check box 236. For example, “biology,” “chemistry,” and “composition” are listed above check box 236. The second special interaction instruction, “select and select all above,” refers to check box 236 and all check boxes in the field of study list above check box 236. The third special interaction instruction, “select all below,” refers to all check boxes in the field of study list below check box 236. For example, “foreign language,” “literature,” “math,” “painting,” and “percussion” are listed below check box 236. The fourth special interaction instruction, “select and select all below,” refers to check box 236 and all check boxes in the field of study list below check box 236.

In another embodiment, special interaction instructions 240 include other special interaction instructions. For example, special interaction instructions 240 may include a “deselect all above” instruction, “deselect and deselect all above” instruction, “deselect all below” instruction, and a “deselect and deselect all below” instruction.

In yet another embodiment, special interaction instructions 240 include instructions to select a specific number of check boxes. For example, a special interaction check box is associated with the instruction “select 3 below.” If this special interaction check box is selected, check box interaction program 40 automatically selects the three check boxes below check box 236.

FIG. 2C depicts a display of UI 245 when check box interaction program 40 is operating on computing device 10. List title 205, check boxes 210, and selection check boxes 215 are the same as FIGS. 2A and 2B. Check box 236 and special interaction instructions 240 are the same as FIG. 2B.

In the depicted embodiment, input device 25 is used to select special interaction instruction 262, which is associated with the special interaction instruction “select all above.” The selected special interaction instruction is indicated by a tick mark (e.g. an “x”). The special interaction instruction associated with special interaction instruction 262, “select all above,” refers to all check boxes in the field of study list that are listed above check box 236.

FIG. 2D depicts a display of UI 270 when check box interaction program 40 is operating on computing device 10. List title 205, check boxes 210, and selection check boxes 215 are the same as FIGS. 2A, 2B, and 2C. Check box 236 is the same as FIG. 2B.

In response to selection of interaction check box 262, shown in FIG. 2C, check box interaction program 40 selects selected check boxes 290. Selected check boxes 290 are all check boxes that are listed above check box 236. Each of selected check boxes 290 are indicated by a tick mark (e.g. an “x”). Check box interaction program 40 selects selected check boxes 290 because selected check boxes 290 are listed above check box 236.

In another embodiment, cursor 237 (not shown) interacts with is hovered over one of check boxes 210 that are not selected. For example, cursor 237 is hovered over check box 283. Check box interaction program 40 displays special interaction instructions associated with special interaction instructions for check boxes that are not selected. For example, check box interaction program 40 displays interaction check boxes associated with the special interaction instructions, “select all above,” select and select all above,” “select all below,” and “select and select all below”.

In yet another embodiment, cursor 237 (not shown) is hovered over one of selected check boxes 290. For example, cursor 237 (not shown) is hovered over selected check box 291. Check box interaction program 40 displays special interaction instructions associated with special interaction instructions for selected check boxes. For example, check box interaction program 40 displays special interaction instructions associated with the special interaction instructions, “deselect all above,” “deselect and deselect all above,” “deselect all below,” and “deselect and deselect all below”.

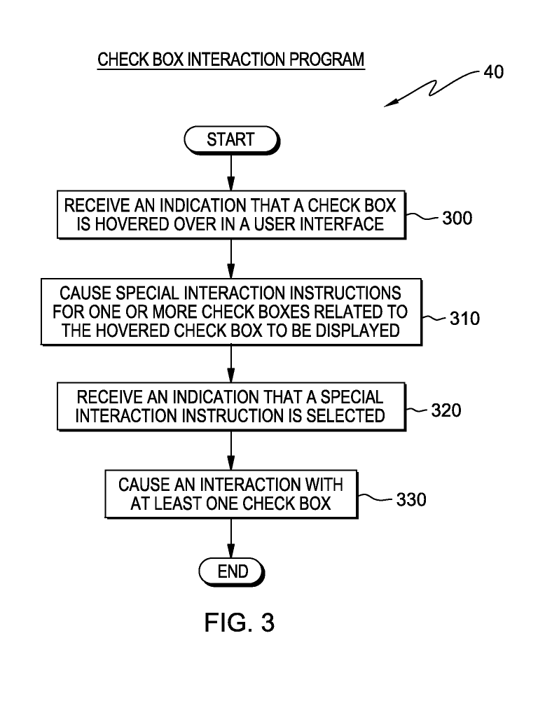

FIG. 3 depicts a flowchart of the steps of check box interaction program 40 for automatically interacting with one or more check boxes in relation to another check box of a plurality of displayed check boxes, in accordance with one embodiment of the present invention.

Initially, in one embodiment, a user, using UI 20 and input device 25, uses software program 30 operating on computing device 10. Software program 30 displays a list of options with corresponding check boxes. In one embodiment, each of the ten options is associated with an unselected check box. In one embodiment, software program 30 displays standard interaction instructions for all ten check boxes associated with the ten options that are listed. For example, standard interaction instructions include “select all” and “deselect all.” In another example, the cursor associated with input device 25 hovers the cursor associated with input device 25 over the eighth unselected check box of the list of ten operational commands corresponding to the eighth option of the list of options.

In step 300, check box interaction program 40 receives an indication that a check box is hovered over in UI 20. In one embodiment, check box interaction program 40 receives an indication from UI 20 that the cursor associated with input device 25 is hovering over the eighth unselected check box of the list of ten operational commands corresponding to the eighth option of the list of options. In another embodiment, check box interaction program 40 receives an indication from software program 30 that the cursor associated with input device 25 is hovering over a selected check box.

In one embodiment, check box interaction program 40 periodically accesses UI 20 to determine the location of the cursor. In another embodiment, UI 20 periodically sends a message that includes the location of the cursor to check box interaction program 40. In yet another embodiment, UI 20 sends an indication to check box interaction program 40 when the cursor hovers over a check box.

In step 310, check box interaction program 40 causes special interaction instructions for one or more check boxes related to the hovered check box to be displayed in UI 20. For example, related check boxes are the nine remaining check boxes that are associated with the list of options that also includes the hovered eighth check box. In one embodiment, check box interaction program 40 causes UI 20 to display a list of special interaction instructions. In another embodiment, check box interaction program 40 sends an instruction to software program 30 to cause UI 20 to display a list of special interaction check boxes. Each instruction is associated with a special interaction instruction that relates to the hovered check box. In one embodiment, the hovered check box and related check boxes are all unselected, so the instructions associated with the displayed special interaction instructions relate to check box selection. For example, an instruction associated with a special interaction check box is “select all above.” In this example, the instruction indicates selection of the seven related check boxes listed above the hovered eighth check box.

In one embodiment, check box interaction program 40 causes special interaction instructions to be displayed in the margin to the right of the list that includes the hovered check box and related check boxes. In another embodiment, check box interaction program 40 causes interaction check boxes to be displayed in the margin to the left of the list that includes the hovered check box and related check boxes. In yet another embodiment, check box interaction program 40 causes a modeless window containing the interaction check boxes to be displayed. In yet another embodiment, check box interaction program 40 causes interaction check boxes to be displayed in a hoverbox.

In step 320, check box interaction program 40 receives an indication that a special interaction instruction is selected. In one embodiment, input device 25 selects a check box associated with a special interaction instruction. For example, input device 25 selects the check box associated with the special interaction instruction “select all above.” In one embodiment, check box interaction program 40 receives an indication from UI 20 that a special interaction instruction is selected. In another embodiment, check box interaction program 40 receives an indication from software program 30 that a special interaction instruction is selected.

In step 330, check box interaction program 40 causes an interaction with at least one check box in the list of displayed check boxes. In one embodiment, check box interaction program 40 sends an instruction to software program 30 to select at least one check box specified by the selected special interaction instructions. An instruction may describe selection of the hovered check box and at least one related check box. For example, check box interaction program 40 instructs software program 30 to select the first eight check boxes. The first eight check boxes include the hovered check box and the seven check boxes listed above the hovered check box. Software program 30, after receiving the instruction from check box interaction program 40, selects the first eight check boxes.

FIG. 4 depicts a block diagram of components of computing device 10 in accordance with one embodiment of the present invention. It should be appreciated that FIG. 4 provides only an illustration of one implementation and does not imply any limitations with regard to the environments in which different embodiments may be implemented. Many modifications to the depicted environment may be made.

Computing device 10 can include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

UI 20, software program 30, and check box interaction program 40 are stored in persistent storage 408 of computing device 10 for execution by one or more of the respective computer processors 404 via one or more memories of memory 406 of computing device 10. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media capable of storing program instructions or digital information.

The media used by persistent storage 408 may also be removable. For example, a removable hard drive may be used for persistent storage 408. Other examples include optical and magnetic disks, thumb drives, and smart cards inserted into a drive for transfer onto another computer-readable storage medium that is also part of persistent storage 408.

Communications unit 410, in these examples, provides for communications with other servers or devices. In these examples, communications unit 410 includes one or more network interface cards. Communications unit 410 may provide communications through the use of either or both physical and wireless communications links. UI 20, software program 30, and check box interaction program 40 may be downloaded to persistent storage 408 of computing device 10 through the respective communications unit 410.

I/O interface(s) 412 allows for input and output of data with other devices that may be connected to computing device 10. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., UI 20, software program 30, and check box interaction program 40, can be stored on such portable computer-readable storage media and can be loaded onto persistent storage 408 of computing device 10 via the respective I/O interface(s) 412 of computing device 10.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automatically interacting with one or more check boxes in relation to another check box of a plurality of displayed check boxes, the method comprising:
one or more processors receiving an indication of an interaction with a check box of the plurality of displayed check boxes in a user interface;
the one or more processors causing instructions for interacting with one or more check boxes of the plurality of check boxes in relation to the interacted with check box to be displayed in the user interface;
the one or more processors receiving an indication that an instruction is selected; and
the one or more processors causing an interaction with the one or more check boxes of the plurality of check boxes, wherein the interaction is specified by the selected instruction.

2. The method of claim 1, wherein the plurality of check boxes is displayed as a vertical list in the user interface.

3. The method of claim 2, wherein the selected instruction is an instruction to select at least one check box above the interacted with check box in the plurality of displayed check boxes.

4. The method of claim 2, wherein the selected instruction is an instruction to select at least one check box below the interacted with check box in the plurality of displayed check boxes.

5. The method of claim 1, wherein the plurality of check boxes are displayed as a horizontal list in the user interface.

6. The method of claim 5, wherein the selected instruction is an instruction to select at least one check box to the left of the interacted with check box in the plurality of displayed check boxes.

7. The method of claim 5, wherein the selected instruction is an instruction to select at least one check box to the right of the interacted with check box in the plurality of displayed check boxes.

8. A computer program product for automatically interacting with one or more check boxes in relation to another check box of a plurality of displayed check boxes, the computer program product comprising:
one or more computer-readable storage media and program instructions stored on the one or more computer-readable storage media, the program instructions comprising:
program instructions to receive an indication of an interaction with a check box of the plurality of displayed check boxes in a user interface;
program instructions to cause instructions for interacting with one or more check boxes of the plurality of check boxes in relation to the interacted with check box to be displayed in the user interface;
program instructions to receive an indication that an instruction is selected; and
program instructions to cause an interaction with the one or more check boxes of the plurality of check boxes, wherein the interaction is specified by the selected instruction.

9. The computer program product of claim 8, wherein the plurality of check boxes is displayed as a vertical list in the user interface.

10. The computer program product of claim 9, wherein the selected instruction is an instruction to select at least one check box above the interacted with check box in the plurality of displayed check boxes.

11. The computer program product of claim 9, wherein the selected instruction is an instruction to select at least one check box below the interacted with check box in the plurality of displayed check boxes.

12. The computer program product of claim 8, wherein the plurality of check boxes are displayed as a horizontal list in the user interface.

13. The computer program product of claim 12, wherein the selected instruction is an instruction to select at least one check box to the left of the interacted with check box in the plurality of displayed check boxes.

14. The computer program product of claim 12, wherein the selected instruction is an instruction to select at least one check box to the right of the interacted with check box in the plurality of displayed check boxes.

15. A computer system for automatically interacting with one or more check boxes in relation to another check box of a plurality of displayed check boxes, the computer system comprising:
one or more computer processors;
one or more computer-readable storage media;
program instructions stored on the computer-readable storage media for execution by at least one of the one or more processors, the program instructions comprising:
program instructions to receive an indication of an interaction with a check box of the plurality of displayed check boxes in a user interface;
program instructions to cause instructions for interacting with one or more check boxes of the plurality of check boxes in relation to the interacted with check box to be displayed in the user interface;
program instructions to receive an indication that an instruction is selected; and
program instructions to cause an interaction with the one or more check boxes of the plurality of check boxes, wherein the interaction is specified by the selected instruction.

16. The computer system of claim 15, wherein the plurality of check boxes is displayed as a vertical list in the user interface.

17. The computer system of claim 16, wherein the selected instruction is an instruction to select at least one check box above the interacted with check box in the plurality of displayed check boxes.

18. The computer system of claim 16, wherein the selected instruction is an instruction to select at least one check box below the interacted with check box in the plurality of displayed check boxes.

19. The computer system of claim 15, wherein the plurality of check boxes are displayed as a horizontal list in the user interface.

20. The computer system of claim 19, wherein the selected instruction is an instruction to select at least one check box to the left of the interacted with check box in the plurality of displayed check boxes.
